(19) United States
(12) Patent Application Publication
(10) Pub. No.: US 2024/0155547 A1
(43) Pub. Date: May 9, 2024

(54) APPARATUS, METHOD, AND COMPUTER PROGRAM PRODUCT FOR RADIO MODEL GENERATION, MOBILE DEVICE POSITIONING, AND/OR HASH KEY GENERATION FOR A RADIO MODEL

(71) Applicant: HERE GLOBAL B.V., Eindhoven (NL)

(72) Inventors: Pavel Ivanov, Tampere (FI); Henri Jaakko Julius Nurminen, Tampere (FI); Marko Luomi, Lempaala (FI); Lauri Aarne Johannes Wirola, Tampere (FI)

(21) Appl. No.: 18/053,169

(22) Filed: Nov. 7, 2022

(51) Int. Cl. H04W 64/00; G01S 5/02

(52) U.S. Cl. CPC H04W 64/003; G01S 5/0252; G01S 5/0284

(57) ABSTRACT

An apparatus, method, and computer program product are provided for radio model generation, mobile device positioning, and/or hash key generation for a radio model. In this regard, a presence of a first radio node in a radio environment is determined. Additionally, at least one hash of the first radio node is determined based at least in part on radio node data for a second radio node in the radio environment. At least a portion of a radio model for the first radio node is then configured based on the at least one hash.

### TECHNOLOGICAL FIELD

An example embodiment of the present disclosure generally relates to positioning system technologies for mobile devices and, more particularly, to an apparatus, method, and computer program product for radio model generation, mobile device positioning, and/or hash key generation for a radio model.

### BACKGROUND

Data for radio nodes and/or mobile devices is often employed for radio models, map creation and/or other purposes to facilitate location-based services for technologies such as, for example, mobile device location-based services, autonomous vehicle navigation, vehicle fleet management, real-time traffic applications, etc. However, traditional map-matching processes are often resource intensive and/or often require processing capacity in addition to any latency that may be experienced. Further, map-matching of a radio node or a mobile device to a location within a map may present privacy issues.

### BRIEF SUMMARY

An apparatus, method, and computer program product are provided in order to provide radio model generation, mobile device positioning, and/or hash key generation for a radio model. As such, precision and/or confidence of predicted locations for mobile device positioning, navigation, routing, and/or journey planning purposes can be improved.

In an example embodiment, an apparatus is configured for radio map generation. The apparatus includes processing circuitry and at least one memory including computer program code instructions that are configured to, when executed by the processing circuitry, cause the apparatus to determine a presence of a first radio node in a radio environment. The computer program code instructions are also configured to, when executed by the processing circuitry, cause the apparatus to determine at least one hash of the first radio node based at least in part on radio node data for a second radio node in the radio environment. The computer program code instructions are also configured to, when executed by the processing circuitry, cause the apparatus to configure at least a portion of a radio model for the first radio node based on the at least one hash.

In one or more embodiments, the computer program code instructions are also configured to, when executed by the processing circuitry, cause the apparatus to determine the at least one hash of the first radio node based at least in part on location data for a mobile device in the radio environment.

In one or more embodiments, the computer program code instructions are also configured to, when executed by the processing circuitry, cause the apparatus to determine the at least one hash of the first radio node based at least in part on identification data for the second radio node.

In one or more embodiments, the computer program code instructions are also configured to, when executed by the processing circuitry, cause the apparatus to determine the at least one hash of the first radio node based at least in part on a predefined hash function associated with a classification of the second radio node data.

In one or more embodiments, the computer program code instructions are also configured to, when executed by the processing circuitry, cause the apparatus to determine the second radio node based at least in part on a signal strength associated with the second radio node.

In one or more embodiments, the computer program code instructions are also configured to, when executed by the processing circuitry, cause the apparatus to determine the second radio node based at least in part on timing data with respect to determination of the presence of the first radio node in the radio environment.

In one or more embodiments, the computer program code instructions are also configured to, when executed by the processing circuitry, cause the apparatus to determine the second radio node based at least in part on a coverage area associated with the first radio node.

In one or more embodiments, the computer program code instructions are also configured to, when executed by the processing circuitry, cause the apparatus to generate the radio model based on the at least one hash in response to a determination that a previously generated radio model does not exist for the at least one hash.

In one or more embodiments, the computer program code instructions are also configured to, when executed by the processing circuitry, cause the apparatus to combine a first radio model and a second radio model to provide the radio model based on the at least one hash in response to a determination that the first radio model and the second radio model are both associated with a corresponding hash.

In one or more embodiments, the computer program code instructions are also configured to, when executed by the processing circuitry, cause the apparatus to update one or more portions of the radio model based on the at least one hash.

In another example embodiment, a computer-implemented method is provided for radio map generation. The computer-implemented method includes determining a presence of a first radio node in a radio environment. The computer-implemented method also includes determining at least one hash of the first radio node based at least in part on radio node data for a second radio node in the radio environment. The computer-implemented method also includes configuring at least a portion of a radio model for the first radio node based on the at least one hash.

In one or more embodiments, the computer-implemented method also includes determining the at least one hash of the first radio node based at least in part on location data for a mobile device in the radio environment.

In one or more embodiments, the computer-implemented method also includes determining the at least one hash of the first radio node based at least in part on identification data for the second radio node.

In one or more embodiments, the computer-implemented method also includes determining the at least one hash of the first radio node based at least in part on a predefined hash function associated with a classification of the second radio node data.

In one or more embodiments, the computer-implemented method also includes determining the second radio node based at least in part on a signal strength associated with the second radio node.

In one or more embodiments, the computer-implemented method also includes determining the second radio node based at least in part on timing data with respect to determination of the presence of the first radio node in the radio environment.

In one or more embodiments, the computer-implemented method also includes determining the second radio node based at least in part on a coverage area associated with the first radio node.

In one or more embodiments, the computer-implemented method also includes generating the radio model based on the at least one hash in response to a determination that a previously generated radio model does not exist for the at least one hash.

In one or more embodiments, the computer-implemented method also includes combining a first radio model and a second radio model to provide the radio model based on the at least one hash in response to a determination that the first radio model and the second radio model are both associated with a corresponding hash.

In one or more embodiments, the computer-implemented method also includes updating one or more portions of the radio model based on the at least one hash.

In another example embodiment, a computer program product is provided. The computer program product includes at least one non-transitory computer readable storage medium having computer-executable program code instructions stored therein with the computer-executable program code instructions including program code instructions configured, upon execution, to determine a presence of a first radio node in a radio environment. The computer-executable program code instructions are also configured to determine at least one hash of the first radio node based at least in part on radio node data for a second radio node in the radio environment. The computer-executable program code instructions are also configured to configure at least a portion of a radio model for the first radio node based on the at least one hash.

In one or more embodiments, the computer-executable program code instructions are also configured to determine the at least one hash of the first radio node based at least in part on location data for a mobile device in the radio environment.

In one or more embodiments, the computer-executable program code instructions are also configured to determine the at least one hash of the first radio node based at least in part on identification data for the second radio node.

In one or more embodiments, the computer-executable program code instructions are also configured to determine the at least one hash of the first radio node based at least in part on a predefined hash function associated with a classification of the second radio node data.

In one or more embodiments, the computer-executable program code instructions are also configured to determine the second radio node based at least in part on a signal strength associated with the second radio node.

In one or more embodiments, the computer-executable program code instructions are also configured to determine the second radio node based at least in part on timing data with respect to determination of the presence of the first radio node in the radio environment.

In one or more embodiments, the computer-executable program code instructions are also configured to determine the second radio node based at least in part on a coverage area associated with the first radio node.

In one or more embodiments, the computer-executable program code instructions are also configured to generate the radio model based on the at least one hash in response to a determination that a previously generated radio model does not exist for the at least one hash.

In one or more embodiments, the computer-executable program code instructions are also configured to combine a first radio model and a second radio model to provide the radio model based on the at least one hash in response to a determination that the first radio model and the second radio model are both associated with a corresponding hash.

In one or more embodiments, the computer-executable program code instructions are also configured to update one or more portions of the radio model based on the at least one hash.

In yet another example embodiment, an apparatus is provided that includes means for determining a presence of a first radio node in a radio environment. The apparatus of this example embodiment also includes means for determining at least one hash of the first radio node based at least in part on radio node data for a second radio node in the radio environment. The apparatus of this example embodiment also includes means for configuring at least a portion of a radio model for the first radio node based on the at least one hash.

In one or more embodiments, the apparatus of this example embodiment also includes means for determining the at least one hash of the first radio node based at least in part on location data for a mobile device in the radio environment.

In one or more embodiments, the apparatus of this example embodiment also includes means for determining the at least one hash of the first radio node based at least in part on identification data for the second radio node.

In one or more embodiments, the apparatus of this example embodiment also includes means for determining the at least one hash of the first radio node based at least in part on a predefined hash function associated with a classification of the second radio node data.

In one or more embodiments, the apparatus of this example embodiment also includes means for determining the second radio node based at least in part on a signal strength associated with the second radio node.

In one or more embodiments, the apparatus of this example embodiment also includes means for determining the second radio node based at least in part on timing data with respect to determination of the presence of the first radio node in the radio environment.

In one or more embodiments, the apparatus of this example embodiment also includes means for determining the second radio node based at least in part on a coverage area associated with the first radio node.

In one or more embodiments, the apparatus of this example embodiment also includes means for generating the radio model based on the at least one hash in response to a determination that a previously generated radio model does not exist for the at least one hash.

In one or more embodiments, the apparatus of this example embodiment also includes means for combining a first radio model and a second radio model to provide the radio model based on the at least one hash in response to a determination that the first radio model and the second radio model are both associated with a corresponding hash.

In one or more embodiments, the apparatus of this example embodiment also includes means for updating one or more portions of the radio model based on the at least one hash.

In another example embodiment, an apparatus is configured for mobile device positioning. The apparatus includes processing circuitry and at least one memory including computer program code instructions that are configured to, when executed by the processing circuitry, cause the apparatus to determine a presence of a first radio node in a radio environment. The computer program code instructions are also configured to, when executed by the processing circuitry, cause the apparatus to determine at least one hash of the first radio node based at least in part on a predefined hash function and a hash key associated with radio node data for a second radio node in the radio environment. The computer program code instructions are also configured to, when executed by the processing circuitry, cause the apparatus to retrieve a radio model from a radio model database based on the at least one hash. The computer program code instructions are also configured to, when executed by the processing circuitry, cause the apparatus to estimate a location of a mobile device based on the radio model retrieved from the radio model database.

In one or more embodiments, the computer program code instructions are also configured to, when executed by the processing circuitry, cause the apparatus to determine the at least one hash of the first radio node based at least in part on location data for one or more mobile devices in the radio environment.

In one or more embodiments, the computer program code instructions are also configured to, when executed by the processing circuitry, cause the apparatus to determine the at least one hash of the first radio node based at least in part on identification data for the second radio node.

In one or more embodiments, the computer program code instructions are also configured to, when executed by the processing circuitry, cause the apparatus to determine the second radio node based at least in part on a signal strength associated with the second radio node.

In one or more embodiments, the computer program code instructions are also configured to, when executed by the processing circuitry, cause the apparatus to determine the second radio node based at least in part on a timing data with respect to determination of the presence of the first radio node in the radio environment.

In one or more embodiments, the computer program code instructions are also configured to, when executed by the processing circuitry, cause the apparatus to determine the second radio node based at least in part on a coverage area associated with the first radio node.

In another example embodiment, a computer-implemented method is provided for mobile device positioning. The computer-implemented method includes determining a presence of a first radio node in a radio environment. The computer-implemented method also includes determining at least one hash of the first radio node based at least in part on a predefined hash function and a hash key associated with radio node data for a second radio node in the radio environment. The computer-implemented method also includes retrieving a radio model from a radio model database based on the at least one hash. The computer-implemented method also includes estimating a location of a mobile device based on the radio model retrieved from the radio model database.

In one or more embodiments, the computer-implemented method also includes determining the at least one hash of the first radio node based at least in part on location data for one or more mobile devices in the radio environment.

In one or more embodiments, the computer-implemented method also includes determining the at least one hash of the first radio node based at least in part on identification data for the second radio node.

In one or more embodiments, the computer-implemented method also includes determining the second radio node based at least in part on a signal strength associated with the second radio node.

In one or more embodiments, the computer-implemented method also includes determining the second radio node based at least in part on a timing data with respect to determination of the presence of the first radio node in the radio environment.

In one or more embodiments, the computer-implemented method also includes determining the second radio node based at least in part on a coverage area associated with the first radio node.

In another example embodiment, a computer program product is provided. The computer program product includes at least one non-transitory computer readable storage medium having computer-executable program code instructions stored therein with the computer-executable program code instructions including program code instructions configured, upon execution, to determine a presence of a first radio node in a radio environment. The computer-executable program code instructions are also configured to determine at least one hash of the first radio node based at least in part on a predefined hash function and a hash key associated with radio node data for a second radio node in the radio environment. The computer-executable program code instructions are also configured to retrieve a radio model from a radio model database based on the at least one hash. The computer-executable program code instructions are also configured to estimate a location of a mobile device based on the radio model retrieved from the radio model database.

In one or more embodiments, the computer-executable program code instructions are also configured to determine the at least one hash of the first radio node based at least in part on location data for one or more mobile devices in the radio environment.

In one or more embodiments, the computer-executable program code instructions are also configured to determine the at least one hash of the first radio node based at least in part on identification data for the second radio node.

In one or more embodiments, the computer-executable program code instructions are also configured to determine the second radio node based at least in part on a signal strength associated with the second radio node.

In one or more embodiments, the computer-executable program code instructions are also configured to determine the second radio node based at least in part on a timing data with respect to determination of the presence of the first radio node in the radio environment.

In one or more embodiments, the computer-executable program code instructions are also configured to determine the second radio node based at least in part on a coverage area associated with the first radio node.

In yet another example embodiment, an apparatus is provided that includes means for determining a presence of a first radio node in a radio environment. The apparatus of this example embodiment also includes means for determining at least one hash of the first radio node based at least in part on a predefined hash function and a hash key associated with radio node data for a second radio node in the radio environment. The apparatus of this example embodiment also includes means for retrieving a radio model from a radio model database based on the at least one hash. The apparatus of this example embodiment also includes means for estimating a location of a mobile device based on the radio model retrieved from the radio model database.

In one or more embodiments, the apparatus of this example embodiment also includes means for determining the at least one hash of the first radio node based at least in part on location data for one or more mobile devices in the radio environment.

In one or more embodiments, the apparatus of this example embodiment also includes means for determining the at least one hash of the first radio node based at least in part on identification data for the second radio node.

In one or more embodiments, the apparatus of this example embodiment also includes means for determining the second radio node based at least in part on a signal strength associated with the second radio node.

In one or more embodiments, the apparatus of this example embodiment also includes means for determining the second radio node based at least in part on a timing data with respect to determination of the presence of the first radio node in the radio environment.

In one or more embodiments, the apparatus of this example embodiment also includes means for determining the second radio node based at least in part on a coverage area associated with the first radio node.

In another example embodiment, an apparatus is configured for hash key generation for a radio model. The apparatus includes processing circuitry and at least one memory including computer program code instructions that are configured to, when executed by the processing circuitry, cause the apparatus to determine a presence of a first radio node in a radio environment. The computer program code instructions are also configured to, when executed by the processing circuitry, cause the apparatus to determine a hash key based at least in part on radio node data for a second radio node in the radio environment or location data for a mobile device in the radio environment. The computer program code instructions are also configured to, when executed by the processing circuitry, cause the apparatus to obfuscate one or more portions of the hash key to generate an obfuscated hash key. The computer program code instructions are also configured to, when executed by the processing circuitry, cause the apparatus to transmit the obfuscated hash key to a server configured to manage radio models for radio nodes.

In one or more embodiments, the computer program code instructions are also configured to, when executed by the processing circuitry, cause the apparatus to determine the hash key based at least in part on identification data for the second radio node.

In one or more embodiments, the computer program code instructions are also configured to, when executed by the processing circuitry, cause the apparatus to determine the hash key based at least in part on location data for the second radio node.

In one or more embodiments, the computer program code instructions are also configured to, when executed by the processing circuitry, cause the apparatus to determine the second radio node based at least in part on a signal strength associated with the second radio node.

In another example embodiment, a computer-implemented method is provided for hash key generation for a radio model. The computer-implemented method includes determining a presence of a first radio node in a radio environment. The computer-implemented method also includes determining a hash key based at least in part on radio node data for a second radio node in the radio environment or location data for a mobile device in the radio environment. The computer-implemented method also includes obfuscating one or more portions of the hash key to generate an obfuscated hash key. The computer-implemented method also includes transmitting the obfuscated hash key to a server configured to manage radio models for radio nodes.

In one or more embodiments, the computer-implemented method also includes determining the hash key based at least in part on identification data for the second radio node.

In one or more embodiments, the computer-implemented method also includes determining the hash key based at least in part on location data for the second radio node

In one or more embodiments, the computer-implemented method also includes determining the second radio node based at least in part on a signal strength associated with the second radio node.

In another example embodiment, a computer program product is provided. The computer program product includes at least one non-transitory computer readable storage medium having computer-executable program code instructions stored therein with the computer-executable program code instructions including program code instructions configured, upon execution, to determine a presence of a first radio node in a radio environment. The computer-executable program code instructions are also configured to determine a hash key based at least in part on radio node data for a second radio node in the radio environment or location data for a mobile device in the radio environment. The computer-executable program code instructions are also configured to obfuscate one or more portions of the hash key to generate an obfuscated hash key. The computer-executable program code instructions are also configured to transmit the obfuscated hash key to a server configured to manage radio models for radio nodes.

In one or more embodiments, the computer-executable program code instructions are also configured to determine the hash key based at least in part on identification data for the second radio node.

In one or more embodiments, the computer-executable program code instructions are also configured to determine the hash key based at least in part on location data for the second radio node.

In one or more embodiments, the computer-executable program code instructions are also configured to determine the second radio node based at least in part on a signal strength associated with the second radio node.

In yet another example embodiment, an apparatus is provided that includes means for determining a presence of a first radio node in a radio environment. The apparatus of this example embodiment also includes means for determining a hash key based at least in part on radio node data for a second radio node in the radio environment or location data for a mobile device in the radio environment. The apparatus of this example embodiment also includes means for obfuscating one or more portions of the hash key to generate an obfuscated hash key. The apparatus of this example embodiment also includes means for transmitting the obfuscated hash key to a server configured to manage radio models for radio nodes.

In one or more embodiments, the apparatus of this example embodiment also includes means for determining the hash key based at least in part on identification data for the second radio node.

In one or more embodiments, the apparatus of this example embodiment also includes means for determining the hash key based at least in part on location data for the second radio node.

In one or more embodiments, the apparatus of this example embodiment also includes means for determining the second radio node based at least in part on a signal strength associated with the second radio node.

### BRIEF DESCRIPTION OF THE DRAWINGS

Having thus described certain embodiments of the disclosure in general terms, reference will now be made to the accompanying drawings, which are not necessarily drawn to scale, and wherein:

FIG. 1 is a block diagram of a system including an apparatus configured for radio model generation, mobile device positioning, and/or hash key generation for a radio model in accordance with one or more example embodiments of the present disclosure;

FIG. 2 is a flowchart illustrating operations performed, such as by the apparatus of FIG. 1, in order to provide radio model generation, mobile device positioning, and/or hash key generation for a radio model in accordance with one or more example embodiments of the present disclosure;

FIG. 3 illustrates a system related to radio nodes in a radio environment in accordance with one or more example embodiments of the present disclosure;

FIG. 4 illustrates a data flow diagram of a system related to the apparatus of FIG. 1 for radio map generation in accordance with one or more example embodiments of the present disclosure;

FIG. 5 illustrates a data flow diagram of a system related to the apparatus of FIG. 1 for mobile device positioning in accordance with one or more example embodiments of the present disclosure;

FIG. 6 illustrates a data flow diagram of a system related to the apparatus of FIG. 1 for hash key generation for a radio model in accordance with one or more example embodiments of the present disclosure; and

FIG. 7 is an example embodiment of an architecture specifically configured for implementing embodiments described herein.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure can be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms can be used interchangeably to refer to data capable of being transmitted, received and/or stored in accordance with embodiments of the present disclosure. Thus, use of any such terms should not be taken to limit the spirit and scope of embodiments of the present disclosure.

Various positioning systems have been developed for determining the position of a mobile device, such as a smart phone or other types of user equipment. At least some of these positioning systems utilize radio models of wireless access points that, in turn, are based on probe points that have been collected by a plurality of mobile devices. The wireless access points may be part of a cellular system or a non-cellular system. For example, a cellular system may include, but is not limited to, a Global System for Mobile communications (GSM) system, a wideband code division multiple access (WCDMA) system, a time division synchronous code division system multiple access (TD-SCDMA) system, a Long Term Evolution (LTE) system, a Long Term Evolution Advanced (LTE-A) system, a code division multiple access (CDMA) system, a NarrowBand-Internet of Things (NB-IoT) system, a fourth-generation (4G) system, a fifth-generation (5G) system, sixth-generation (6G) system, or another type of cellular system. A non-cellular system may include, but is not limited to, a Wireless Local Area Network (WLAN) system, a Bluetooth (BT) system, a Bluetooth Low Energy (BTLE) system, a Zigbee system, a long range (LoRa) system, or another type of non-cellular system.

In relation to the radio models of wireless access points that are utilized by positioning systems, databases containing information regarding the radio signals received by mobile devices at different locations relative to the access points are created. Accordingly, a large portion of the information in the databases generally originates from the mobile devices. Collection of information from mobile devices in this way is generally referred to as crowdsourcing.

In this regard, the databases are typically formed of data provided by the mobile devices in the form of probe points. Each probe point includes an estimate of the location of the mobile device at the time at which the radio signals were captured and a measurement of the radio signals that were captured. With respect to cellular signals, the measurement of the cellular signals may include an identification of the access point, that is, the cellular network cell, e.g., base station, that is transmitting the cellular signals that are received by the mobile device, such as a global and/or local identifier (ID) of the cellular network cell. The measurement of the cellular signals may also include a measurement of the signal strength and/or an estimate of the path loss as well as a timing measurement, such as a Timing Advance measurement or a Round-Trip Time measurement. With respect to the measurement of a non-cellular signal, the measurement may include an identification of the access point generating the non-cellular signals that are received by the mobile device, such as the basic service set identifiers (BSSIDs), e.g., a media access control (MAC) address of the air interface of an access point, e.g., a WLAN access point, or the service set identifier (SSID) or network name of the access point, e.g., WLAN access point. The measurement of a non-cellular signal also includes a measure of the signal strength, such as the received signal strength, the receiver level, etc. and/or a path loss estimate. In some embodiments, the measurement of a non-cellular signal also includes a timing measurement, such as the Round-Trip Time measurement.

The data, such as the probe points, collected by the plurality of mobile devices is generally uploaded, such as to a server or the cloud. By reference to the data, the positioning system then generates or updates radio models of the wireless access points that define the signal characteristics of radio signals that are transmitted by the wireless access points and received by mobile devices at different respective locations. In certain implementations, a radio model of a positioning environment can employ one or more portions of the data as training data for the radio model. The radio model may then be utilized for positioning purposes, that is, to determine the location of a mobile device based upon radio signals received by the mobile device at the respective location. Various radio models may be constructed including radio models based upon the coverage areas of the access points, radio models based upon the positions of the access points, radio propagation models, radio models based upon the receiver fields of the access points or the like. The resulting radio models may be stored by one or more network entities, such as by the positioning system, and/or may be transferred to one or more of the mobile devices.

The radio models may then be utilized to determine the position of a mobile device. For example, while a mobile device is at an unknown location, the mobile device may capture measurements of the cellular or non-cellular signals transmitted by the access points. By reference to the radio models that have been constructed, the measurements of the radio signals may be evaluated, and the location of the mobile terminal may be determined, such as based upon the coverage areas of the access points.

However, the quality of data employed by radio models is generally associated with an accuracy value and a privacy value. The accuracy value is generally related to the intrinsic utility of the data towards generation of a radio model. The privacy value generally reflects the sensitive information that the data reveals about a respective user of a mobile device and/or an access point (e.g., a radio node). Furthermore, the privacy value also generally reflects risk of the data being related to an inadvertent disclosure or misuse of the data. Accordingly, it is generally desirable to collect as much data as possible in order to maximize the accuracy of the radio model, while also minimizing the associated risks for the privacy of users and/or access points. For example, since radio node identifiers and/or a corresponding radio node location is generally considered private information, it is generally desirable for a database of radio node identifiers and locations to be secured.

To address these and/or other issues, an apparatus, method, and computer program product are provided in accordance with an example embodiment in order to provide for radio model generation, mobile device positioning, and/or hash key generation for a radio model. In various embodiments, certain types of data employed by radio nodes such as, but not limited to, radio node identifiers, can be anonymized to provide improved security and/or accuracy of data employed by radio models. In various embodiments, radio database information and/or employment of the radio database information for location services associated with mapping, routing and/or navigation can be secured by hashing radio node identifiers using neighbor radio node identifiers. Additionally or alternatively, radio database information and/or employment of the radio database information for location services associated with mapping, routing and/or navigation can be secured by hashing coarse location information associated with a mobile device.

For radio model (e.g., radio map) generation embodiments, at least one hash of a radio node identifier can be determined for each radio measure in a radio scan. The least one hash of the radio node identifier can be determined using a predefined hash function and/or at least one of an identifier for a second radio node (e.g., a cellular network identifier, a WiFi network identifier, etc.) and/or coarse location information for a mobile device as a key. At least one of the identifier and/or coarse location information for the mobile device can be determined according to one or more predefined rules. In various embodiments, the one or more predefined rules can be, for example, selecting only radio nodes whose received signal strength is higher than a predefined threshold. The hashed identifier can be employed to create, update, and/or combine corresponding radio models. In various embodiments, a radio node may have one or many radio models associated with different hashed identifiers. Additionally, one or more hashed identifiers may be correlated to one or more radio models for a corresponding radio node. In embodiments, where multiple hashed identifiers are generated for a radio node (e.g., based on other radio nodes in a radio scan and/or a coarse prior location of one or more mobile devices), the radio models correlated by these hashed identifiers can be combined.

For mobile device positioning embodiments, a hash of the measured radio node identifiers can be determined for each radio measurement. The hash of the measured radio node identifiers can be determined using a predefined hash function and at least one of an identifier for a second radio node (e.g., a cellular network identifier, a WiFi network identifier, etc.) and/or coarse location information for the mobile device as a key. At least one of the identifier and/or coarse location information for the mobile device can be determined according to one or more predefined rules. The determined hash can then be employed to retrieve a radio model from a database configured to store a set of radio models. Furthermore, a position of a mobile device can be determined based on the radio model retrieved from the database.

As such, by employing one or more techniques related to radio model generation, mobile device positioning, and/or hash key generation for a radio model as disclosed herein, an original identifier for a radio node is not stored in a database such that improved security of the original identifier is provided. Accordingly, possibility of an untrusted source identifying radio nodes and respective locations is minimized even in scenarios where access to the database is compromised. Moreover, radio model generation, mobile device positioning, and/or hash key generation for a radio model as disclosed herein can be employed to provide improved mapping, routing and/or navigation for location services. In certain embodiments, radio model generation, mobile device positioning, and/or hash key generation for a radio model as disclosed herein can be employed to improve accuracy of a radio model and/or a radio model related to location services. Additionally or alternatively, in certain embodiments, radio model generation, mobile device positioning, and/or hash key generation for a radio model as disclosed herein can be employed to provide improved user interfaces associated with mapping, routing and/or navigation. For example, in one or more embodiments, improved location predictions for mobile devices can reduce a number of queries and/or a number of displays associated with a user interface employed for mapping, routing and/or navigation. Computational resources for a mobile device associated with the user interface (e.g., the user interface related to mapping, routing and/or navigation) can also be conserved and/or reduced.

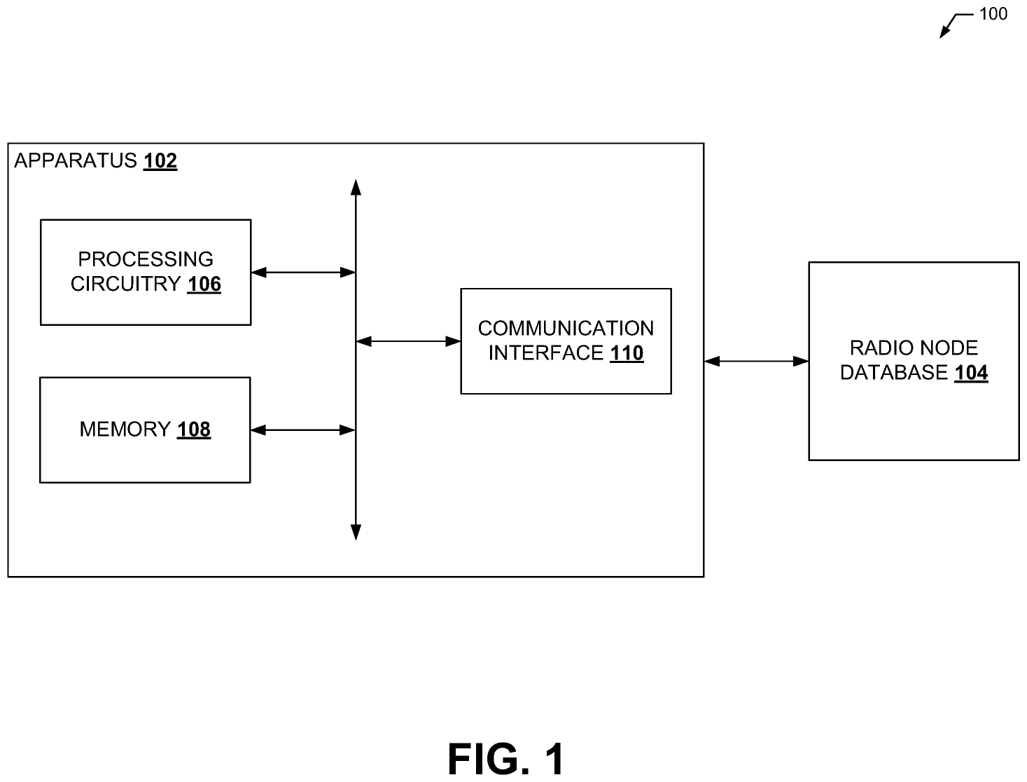

With reference to FIG. 1, a system 100 configured for radio model generation, mobile device positioning, and/or hash key generation for a radio model is depicted, in accordance with one or more embodiments of the present disclosure. In the illustrated embodiment, the system 100 includes an apparatus 102 and a radio node database 104. As described further below, the apparatus 102 is configured in accordance with an example embodiment of the present disclosure to assist positioning, localization, crowdsourcing, mapping, routing, navigation, and/or other applications related to mobile devices. The apparatus 102 can be embodied by any of a wide variety of systems and/or computing devices including, for example, a server system, a cloud-based computing system, a positioning system, a location service system (e.g., a location data and technology platform system, a cloud-based location platform service system, etc.), an urban mobility system, a navigation system, a routing system, a mapping system, a mobile device system, a consumer device system, a vehicle system, a transportation system, a control system, an electronic control unit, an autonomous vehicle control system, an Advanced Driver Assistance System module (ADAS of a vehicle), or another type of system. In certain embodiments, the apparatus 102 may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. Regardless of the type of computing device and/or system that embodies the apparatus 102, the apparatus 102 of an example embodiment includes, is associated with or otherwise is in communication with processing circuitry 106, memory 108 and optionally a communication interface 110.

In some embodiments, the processing circuitry 106 (and/or co-processors or any other processors assisting or otherwise associated with the processing circuitry 106) can be in communication with the memory 108 via a bus for passing information among components of the apparatus 102. The memory 108 can be non-transitory and can include, for example, one or more volatile and/or non-volatile memories. In other words, for example, the memory 108 may be an electronic storage device (for example, a computer readable storage medium) comprising gates configured to store data (for example, bits) that can be retrievable by a machine (for example, a computing device like the processing circuitry 106). The memory 108 can be configured to store information, data, content, applications, instructions, or the like for enabling the apparatus 102 to carry out various functions in accordance with an example embodiment of the present disclosure. For example, the memory 108 can be configured to buffer input data for processing by the processing circuitry 106. Additionally or alternatively, the memory 108 can be configured to store instructions for execution by the processing circuitry 106.

The processing circuitry 106 can be embodied in a number of different ways. For example, the processing circuitry 106 may be embodied as one or more of various hardware processing means such as a processor, a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 106 can include one or more processing cores configured to perform independently. A multi-core processor can enable multiprocessing within a single physical package. Additionally or alternatively, the processing circuitry 106 can include one or more processors configured in tandem via the bus to enable independent execution of instructions, pipelining and/or multithreading.

In an example embodiment, the processing circuitry 106 can be configured to execute instructions stored in the memory 108 or otherwise accessible to the processing circuitry 106. Alternatively or additionally, the processing circuitry 106 can be configured to execute hard coded functionality. As such, whether configured by hardware or software methods, or by a combination thereof, the processing circuitry 106 can represent an entity (for example, physically embodied in circuitry) capable of performing operations according to an embodiment of the present disclosure while configured accordingly. Thus, for example, when the processing circuitry 106 is embodied as an ASIC, FPGA or the like, the processing circuitry 106 can be specifically configured hardware for conducting the operations described herein. Alternatively, as another example, when the processing circuitry 106 is embodied as an executor of software instructions, the instructions can specifically configure the processing circuitry 106 to perform the algorithms and/or operations described herein when the instructions are executed. However, in some cases, the processing circuitry 106 can be a processor of a specific device (for example, a computing device) configured to employ an embodiment of the present disclosure by further configuration of the processor by instructions for performing the algorithms and/or operations described herein. The processing circuitry 106 can include, among other things, a clock, an arithmetic logic unit (ALU) and/or one or more logic gates configured to support operation of the processing circuitry 106.

The apparatus 102 of an example embodiment can also optionally include the communication interface 110 that can be any means such as a device or circuitry embodied in either hardware or a combination of hardware and software that is configured to receive and/or transmit data from/to other electronic devices in communication with the apparatus 102, such as the radio node database 104 that stores radio database information such as, for example, radio node data. The radio node data can include a location reference, a timestamp, and/or one or more measurements obtained from a radio node. For example, the one or more measurements can include an identifier for a radio node, a global identifier of a radio node cell, a local identifier of a radio node cell, a signal strength measurement (e.g., a signal strength index, a receiver level, etc.), a pathloss estimate, a timing measurement (e.g., timing advance or round-trip time), a BSSID of a wireless access point, a MAC of an air interface of a wireless access point, an SSID, a measurement related to an environment associated with a mobile device (e.g., a magnetic field measurement), and/or another type of measurement. The radio node data can additionally or alternatively include user profile data, metadata, and/or other data generated and/or employed by the processing circuitry 106.

Additionally or alternatively, the communication interface 110 can be configured to communicate in accordance with various wireless protocols including, but not limited to, Global System for Mobile Communications (GSM), Long Term Evolution (LTE), 4G, 5G, 6G, etc. In this regard, the communication interface 110 can include, for example, an antenna (or multiple antennas) and supporting hardware and/or software for enabling communications with a wireless communication network. In this regard, the communication interface 110 can include, for example, an antenna (or multiple antennas) and supporting hardware and/or software for enabling communications with a wireless communication network. Additionally or alternatively, the communication interface 110 can include the circuitry for interacting with the antenna(s) to cause transmission of signals via the antenna(s) or to handle receipt of signals received via the antenna(s). In some environments, the communication interface 110 can alternatively or also support wired communication and/or may alternatively support vehicle to vehicle or vehicle to infrastructure wireless links.

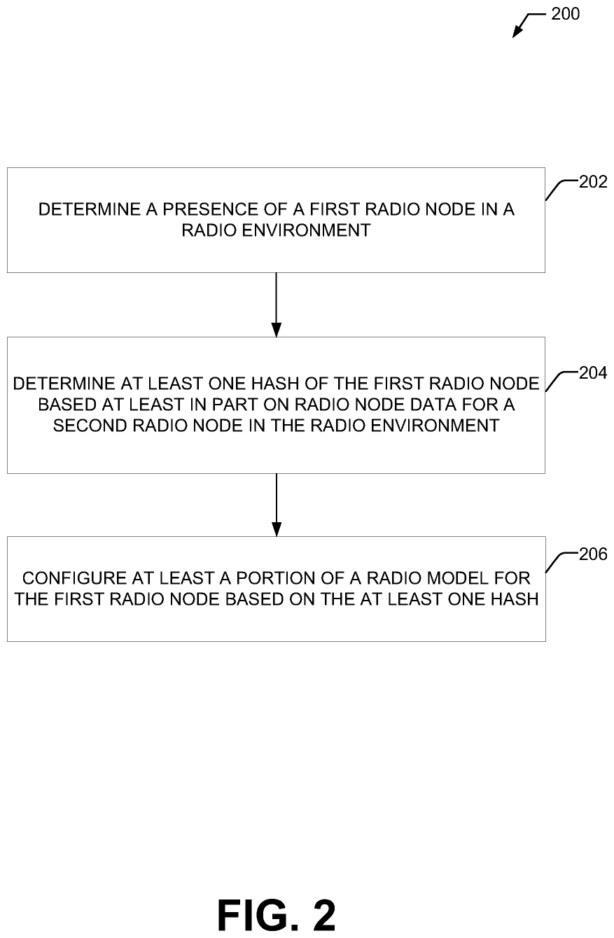

FIG. 2 illustrates a flowchart depicting a method 200 according to an example embodiment of the present disclosure. It will be understood that each block of the flowchart and combination of blocks in the flowchart can be implemented by various means, such as hardware, firmware, processor, circuitry, and/or other communication devices associated with execution of software including one or more computer program instructions. For example, one or more of the procedures described above can be embodied by computer program instructions. In this regard, the computer program instructions which embody the procedures described above can be stored, for example, by the memory 108 of the apparatus 102 employing an embodiment of the present disclosure and executed by the processing circuitry 106. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 2, the operations performed, such as by the apparatus 102 of FIG. 1, in order to provide for radio model generation, mobile device positioning, and/or hash key generation for a radio model, in accordance with one or more embodiments of the present disclosure. As shown in block 202 of FIG. 2, the apparatus 102 includes means, such as the processing circuitry 106, the memory 108, or the like, configured to determine a presence of a first radio node in a radio environment. The radio node can be a radio device such as, for example, an access point of a wireless network. The radio environment can be a communication environment that includes radio nodes and/or one or more mobile devices. In various embodiments, the presence of the first radio node can be determined based on measurement of a cellular signal broadcasted by the first radio node. The measurement can be a radio measure identified during a radio scan of the radio environment. In certain embodiments, the presence of the first radio node can be determined based on a signal strength of the cellular signal satisfying a signal strength threshold value. Additionally or alternatively, the presence of the first radio node can be determined based on a timing measurement, metadata included in the cellular signal, and/or one or more other characteristics associated with the cellular signal.

As shown in block 204 of FIG. 2, the apparatus 102 additionally includes means, such as the processing circuitry 106, the memory 108, or the like, configured to determine at least one hash of the first radio node based at least in part on radio node data for a second radio node in the radio environment. In various embodiments, at least a portion of the radio node data can be generated by a mobile device communicatively coupled to the second radio node. For example, the mobile device can be located in the radio environment with at least the first radio node and the second radio node. Additionally, in various embodiments, the mobile device or the second radio node can provide one or more portions of the radio node data. The radio node data for the second radio node can include, but is not limited to, identification data for the second radio node (e.g., an identifier for the second radio node), location data for the mobile device (e.g., a coarse location or location estimate for the mobile device), one or more predefined hash functions associated with one or more classifications of the second radio node data, a signal strength associated with the second radio node, other measurement data associated with the second radio node, and/or other data associated with the second radio node. In various embodiments, the radio node data can include different predefined hash functions for different classifications for the second radio node and/or the mobile device. For example, the radio node data can include a first predefined hash function for a first classification associated with a cellular network identifier for the second radio node, a second predefined hash function for a second classification associated with a WiFi network identifier for the second radio node, a third predefined hash function for a third classification associated with coarse location information for a mobile device, etc.

In certain embodiments, the apparatus 102, such as the processing circuitry 106, can be configured to determine the second radio node based at least in part on timing data with respect to determination of the presence of the first radio node in the radio environment. For example, the apparatus 102, such as the processing circuitry 106, can be configured to determine the second radio node at approximately the same time as determining the presence of the first radio node in the radio environment via the radio scan of the radio environment. In another example, the apparatus 102, such as the processing circuitry 106, can be configured to determine the second radio node based at least in part on timing of a determination of location data for the mobile device. Additionally or alternatively, the apparatus 102, such as the processing circuitry 106, can be configured to determine the second radio node based at least in part on a coverage area (e.g., a communication area size) associated with the first radio node. For example, the apparatus 102, such as the processing circuitry 106, can be configured to determine the second radio node based at least in part on an effective communication coverage provided by the first radio node.

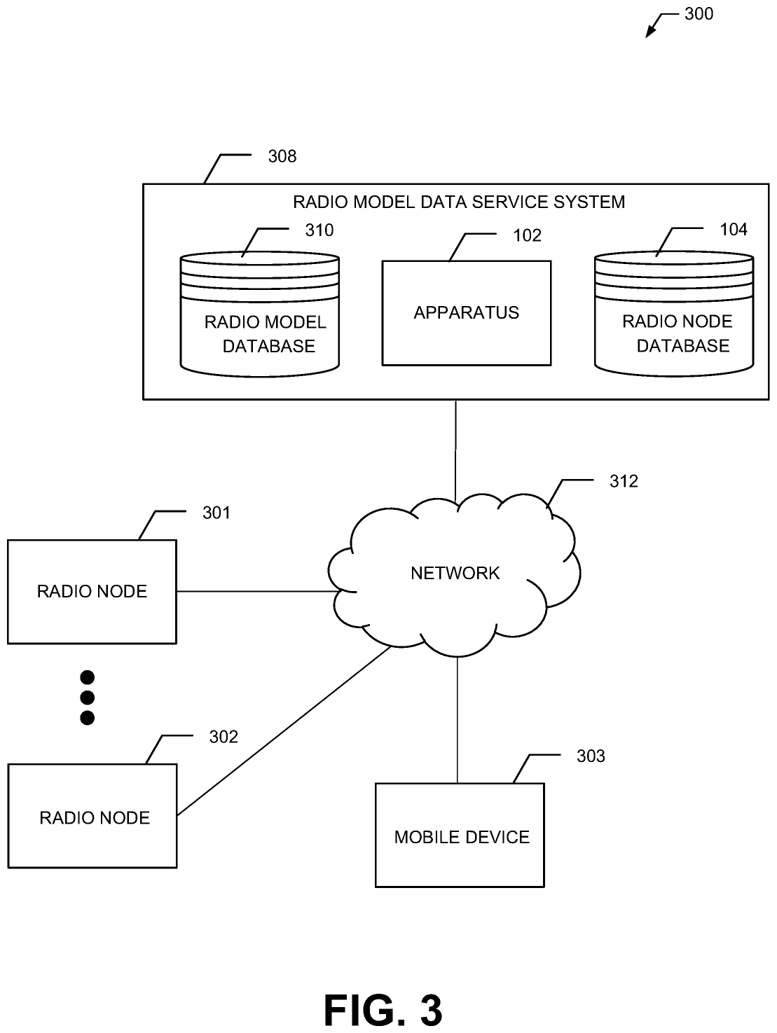

FIG. 3 illustrates a system 300 related to radio nodes node in a radio environment, in accordance with one or more example embodiments of the present disclosure. The system 300 includes a radio node 301, a radio node 302, a mobile device 303, and a radio model data service system 308. The radio node 301, the radio node 302, and/or the radio model data service system 308 can be communicatively coupled via a network 312. The mobile device 303 can be communicatively coupled to the radio node 301 and/or the radio node 302 via one or more wireless communication channels. In certain embodiments, the mobile device 303 can also be communicatively coupled to the radio model data service system 308 via a network 312.

The radio node 301, the radio node 302, and the mobile device 303 can be located in a corresponding radio environment. For example, the radio node 301, the radio node 302, and the mobile device 303 can be located in an outdoor environment or an indoor environment associated with a cellular system or a non-cellular system. The radio node 301 can be an access point (e.g., a wireless access point) associated with a cellular system or a non-cellular system. For example, the radio node 301 can be a communication node of a cellular system such as, but is not limited to, a GSM system, a WCDMA system, a TD-SCDMA system, an LTE system, an LTE-A system, a CDMA system, an NB-IoT system, a 4G system, a 5G system, a 6G system, or another type of cellular system. In another example, the radio node 301 can be a communication node of a non-cellular system such as, but is not limited to, a WLAN system, a BT system, a BTLE system, a Zigbee system, an LoRa system, or another type of non-cellular system.

Similarly, the radio node 302 can be an access point (e.g., a wireless access point) associated with a cellular system or a non-cellular system. For example, the radio node 302 can be a communication node of a cellular system such as, but is not limited to, a GSM system, a WCDMA system, a TD-SCDMA system, an LTE system, an LTE-A system, a CDMA system, an NB-IoT system, a 4G system, a 5G system, a 6G system, or another type of cellular system. In another example, the radio node 302 can be a communication node of a non-cellular system such as, but is not limited to, a WLAN system, a BT system, a BTLE system, a Zigbee system, an LoRa system, or another type of non-cellular system. In various embodiments, the radio node 301 can be a first radio node in the radio environment and the radio node 302 can be a second radio node in the radio environment.

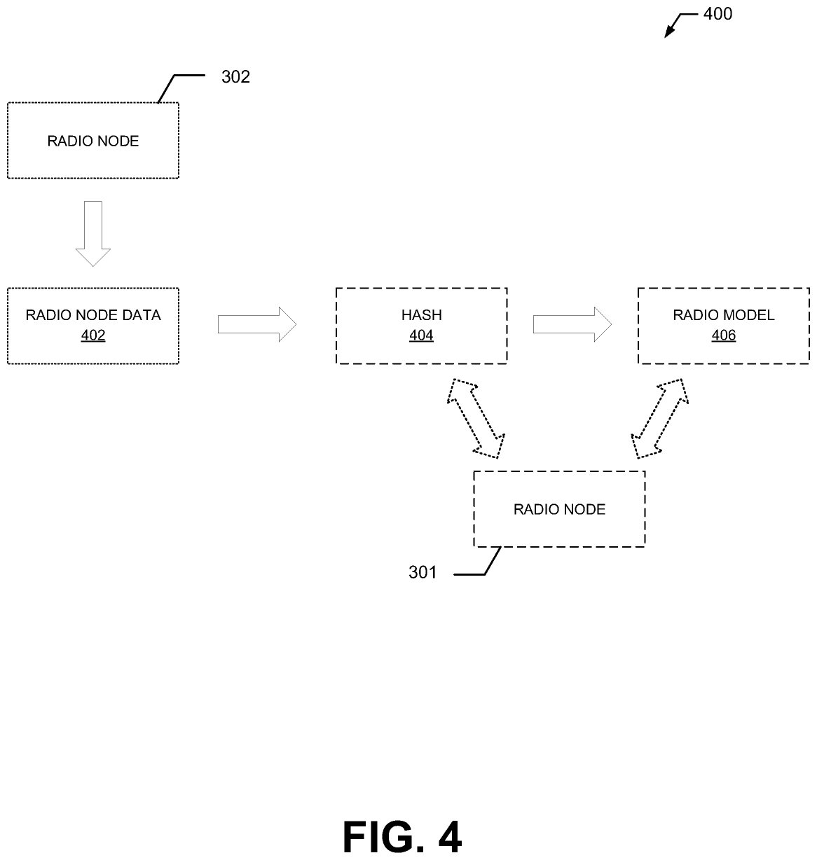

The mobile device 303 can be a mobile phone, a smartphone, a smart device, a wearable device, a navigation system, or another type of mobile device. In one or more embodiments, the mobile device 303 can generate one or more portions of radio node data. Information included in the radio node data can be associated with the radio node 301, the radio node 302, and/or the mobile device 303. For example, in response to determining presence of the radio node 301, the mobile device 303 can determine radio node data for the radio node 302. The radio node data for the radio node 302 (e.g., radio node data 402 illustrated in FIG. 4) can include identification data for the radio node 302, location data associated with a location estimate of the mobile device 303, one or more measurements with respect to the radio node 302, timestamp data associated with one or more measurements with respect to the radio node 302, one or more predefined hash functions associated with one or more classification for the radio node 302, and/or other radio node data associated with the radio node 302.

The one or more measurements can be captured by the mobile device 303 and/or the radio node 302. Additionally, the one or more measurements can include a global identifier of a cellular network cell of the radio node 302, a local identifier of a cellular network cell of the radio node 302, a signal strength measurement (e.g., a signal strength index, a receiver level, etc.) between the mobile device 303 and the radio node 302, a pathloss estimate between the mobile device 303 and the radio node 302, a timing measurement (e.g., timing advance or round-trip time) between the mobile device 303 and the radio node 302, a BSSID of the radio node 302, a MAC of an air interface of the radio node 302, an SSID related to the radio node 302, a measurement related to a radio environment associated with the radio node 302 and/or the mobile device 303 (e.g., a magnetic field measurement associated with the radio node 302 and/or the mobile device 303), another type of measurement associated with the radio node 302, and/or another type of measurement associated with the mobile device 303.

The radio node data can additionally or alternatively include user profile data for a user associated with the mobile device 303, metadata associated with the mobile device 303, and/or other data associated with the mobile device 303. In certain embodiments, the mobile device 303 can be implemented with one or more other mobile devices to collect radio node data during a training stage related to the radio model data service system 308.

The radio model data service system 308 can be associated with a radio model data service provider. In one or more embodiments, the radio model data service system 308 includes the apparatus 102, the radio node database 104, and/or a radio model database 310. In one or more embodiments, the apparatus 102 receives the radio node data from the mobile device 303. The radio model database 310 can store one or more radio models and/or data related to one or more data maps for at least the radio environment associated with the radio node 301, the radio node 302, and/or the mobile device 303. A radio model stored in the radio model database 310 can be configured to enable a mobile device to estimate a position of the mobile device based on one or more measurements captured by a radio interface of the mobile device. In various embodiments, a radio model can be configured as a geometric radio model.

As shown in block 206 of FIG. 2, the apparatus 102 additionally includes means, such as the processing circuitry 106, the memory 108, or the like, configured to configure at least a portion of a radio model for the first radio node based on the at least one hash. For example, the apparatus 102, such as the processing circuitry 106, can be configured to update one or more portions of the radio model based on the at least one hash. In various embodiments, the apparatus 102, such as the processing circuitry 106, can be configured to generate the radio model based on the at least one hash in response to a determination that a previously generated radio model does not exist for the at least one hash. In various embodiments, the apparatus 102, such as the processing circuitry 106, can be configured to combine a first radio model and a second radio model to provide the radio model based on the at least one hash in response to a determination that the first radio model and the second radio model are both associated with a corresponding hash (e.g., a corresponding hashed identifier).

Referring now to FIG. 4, a data flow diagram of a system 400 related to the apparatus 102 is illustrated, in accordance with one or more example embodiments of the present disclosure related to radio map generation. The system 400 includes the radio node 301 and the radio node 302. In various embodiments, in response to determining presence of the radio node 301, radio node data 402 for the radio node 302 can be determined. Additionally, the apparatus 102, such as the processing circuitry 106, can be configured to determine at least one hash 404 of the radio node 301 based at least in part on radio node data 402 for the radio node 302. Moreover, the apparatus 102, such as the processing circuitry 106, can be configured to configure at least a portion of a radio model 406 for the radio node 301 based on the at least one hash 404. The radio model 406 can be a radio model stored in the radio model database 310.

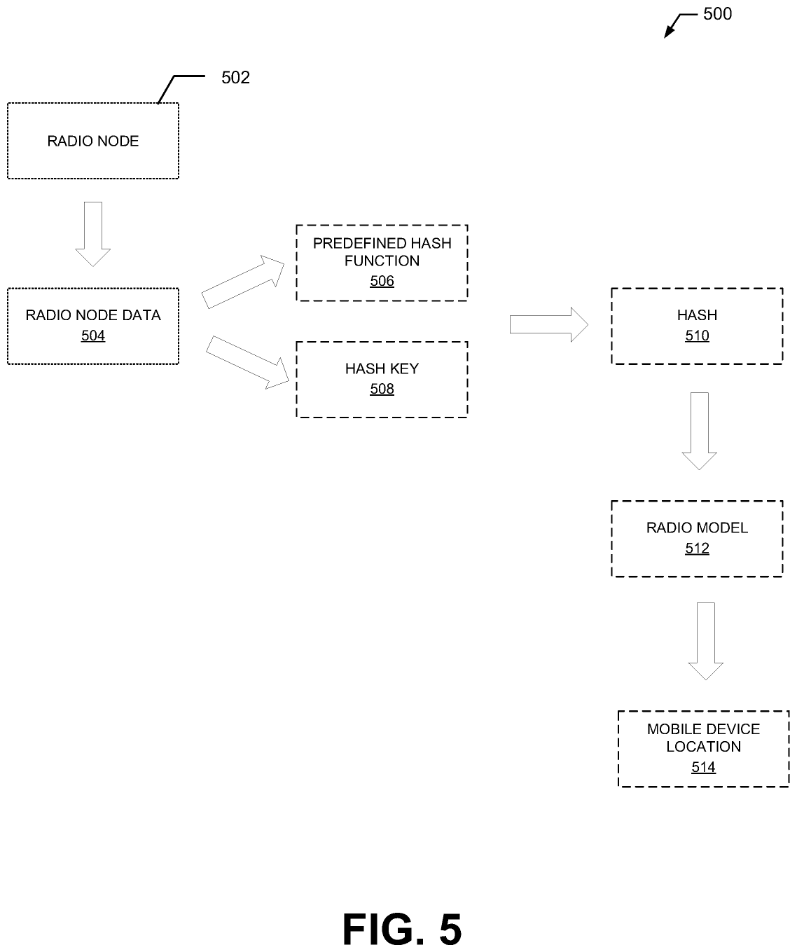

Referring now to FIG. 5, a data flow diagram of a system 500 related to the apparatus 102 is illustrated, in accordance with one or more example embodiments of the present disclosure related to mobile device positioning. The system 500 includes a radio node 502 in a radio environment. In certain embodiments, the apparatus 102 can be implemented in the mobile device 303. As such, in certain embodiments, the apparatus, such as the processing circuitry 106, can be configured to determine a presence of a first radio node in the radio environment. The first radio node can be different than the radio node 502. Additionally, the apparatus, such as the processing circuitry 106, can be configured to determine at least one hash 510 of the radio node 502 based at least in part on a predefined hash function 506 and a hash key 508 associated with radio node data 504 for the radio node 502. The at least one hash 510 can correspond to a hashed identifier for the radio node 502. In an exemplary embodiment, the radio node 502 can be a second radio node and can correspond to the radio node 302 illustrated in FIG. 3. Additionally, the first radio node can correspond to the radio node 301 illustrated in FIG. 3. In certain embodiments, the apparatus, such as the processing circuitry 106, can be configured to determine the radio node 502 based at least in part on a coverage area associated with the first radio node.

In various embodiments, the radio node data 504 can include identification data for the radio node 502, location data associated with a location estimate of one or more mobile devices within the radio environment, one or more measurements with respect to the radio node 502, timestamp data associated with one or more measurements with respect to the radio node 502, one or more predefined hash functions associated with one or more classifications for the radio node 502, and/or other radio node data associated with the radio node 502. The one or more measurements can be captured by the mobile device (e.g., the mobile device 303) and/or the radio node 502. Additionally, the one or more measurements can include a global identifier of a cellular network cell of the radio node 502, a local identifier of a cellular network cell of the radio node 502, a signal strength measurement (e.g., a signal strength index, a receiver level, etc.) between the mobile device and the radio node 502, a pathloss estimate between the mobile device and the radio node 502, a timing measurement (e.g., timing advance or round-trip time) between the mobile device and the radio node 502, a B S SID of the radio node 502, a MAC of an air interface of the radio node 502, an SSID related to the radio node 502, a measurement related to a radio environment associated with the radio node 502 and/or the mobile device (e.g., a magnetic field measurement associated with the radio node 502 and/or the mobile device), another type of measurement associated with the radio node 502, and/or another type of measurement associated with the mobile device.

The apparatus, such as the processing circuitry 106, can also be configured to retrieve a radio model 512 from a radio model database (e.g., the radio model database 310) based on the at least one hash 510. Additionally, the apparatus, such as the processing circuitry 106, can also be configured to estimate a mobile device location 514 (e.g., a location of the mobile device 303) based on the radio model 512 retrieved from the radio model database.

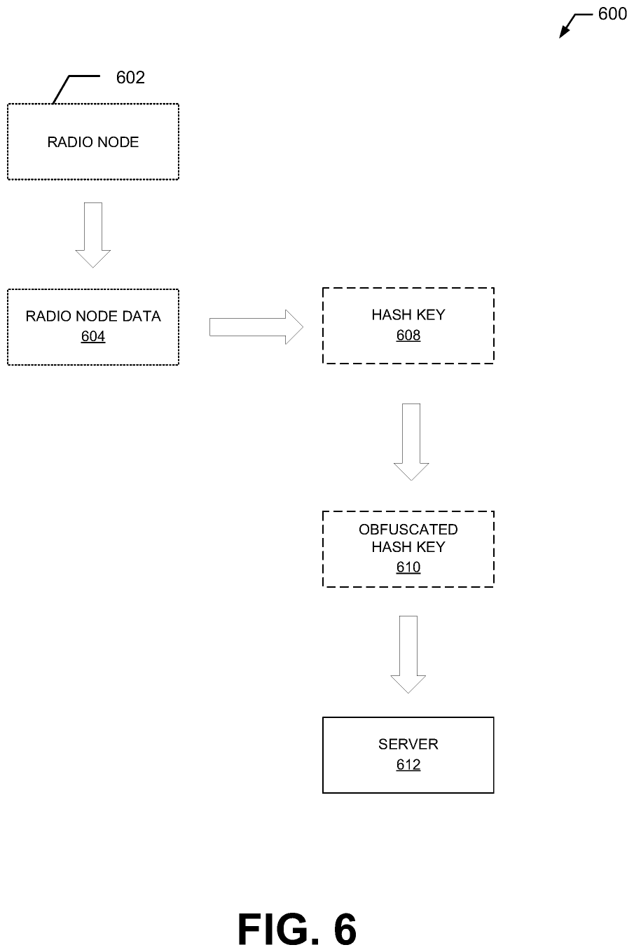

Referring now to FIG. 6, a data flow diagram of a system 600 related to the apparatus 102 is illustrated, in accordance with one or more example embodiments of the present disclosure related to hash key generation for a radio model. The system 600 includes a radio node 602 in a radio environment. In certain embodiments, the apparatus 102 can be implemented in the mobile device 303. As such, in certain embodiments, the apparatus, such as the processing circuitry 106, can be configured to determine a presence of a first radio node in the radio environment. The first radio node can be different than the radio node 602. Additionally, the apparatus, such as the processing circuitry 106, can be configured to determine a hash key 608 based at least in part on radio node data 604 for the radio node 602.

In an exemplary embodiment, the radio node 602 can be a second radio node and can correspond to the radio node 302 illustrated in FIG. 3. Additionally, the first radio node can correspond to the radio node 301 illustrated in FIG. 3. In certain embodiments, the apparatus, such as the processing circuitry 106, can be configured to determine the radio node 602 based at least in part on a coverage area associated with the first radio node.

In various embodiments, the radio node data 604 can include identification data for the radio node 602, location data associated with a location estimate of one or more mobile devices within the radio environment, one or more measurements with respect to the radio node 602, timestamp data associated with one or more measurements with respect to the radio node 602, one or more predefined hash functions associated with one or more classifications for the radio node 602, and/or other radio node data associated with the radio node 602. The one or more measurements can be captured by the mobile device (e.g., the mobile device 303) and/or the radio node 602. Additionally, the one or more measurements can include a global identifier of a cellular network cell of the radio node 602, a local identifier of a cellular network cell of the radio node 602, a signal strength measurement (e.g., a signal strength index, a receiver level, etc.) between the mobile device and the radio node 602, a pathloss estimate between the mobile device and the radio node 602, a timing measurement (e.g., timing advance or round-trip time) between the mobile device and the radio node 602, a B S SID of the radio node 602, a MAC of an air interface of the radio node 602, an SSID related to the radio node 602, a measurement related to a radio environment associated with the radio node 602 and/or the mobile device (e.g., a magnetic field measurement associated with the radio node 602 and/or the mobile device), another type of measurement associated with the radio node 602, and/or another type of measurement associated with the mobile device.

The apparatus, such as the processing circuitry 106, can also be configured to obfuscate one or more portions of the hash key 608 to generate an obfuscated hash key 610. Additionally, the apparatus, such as the processing circuitry 106, can also be configured to transmit the obfuscated hash key 610 to a server 612 configured to manage radio models for radio nodes. For example, the server 612 can correspond to the radio model data service system 308

In certain embodiments, the apparatus 102, such as the processing circuitry 106, can be configured to encode the mobile device location 514 and/or the radio model 406 in a database (e.g., the radio model database 310) to facilitate location and/or position prediction for mobile devices. In certain embodiments, the apparatus 102, such as the processing circuitry 106, can be configured to map the mobile device location 514 onto a map data layer. For example, in certain embodiments, the mobile device location 514 can be employed for location and/or position predictions associated with real-time mapping and/or navigation for mobile devices. In certain embodiments, the apparatus 102, such as the processing circuitry 106, can be configured to provide an optimal end-to-end experience for a user via a user interface of a mobile device, where the mobile device location 514 provides a reduction of queries and/or a reduction in a number of displays associated with user interaction with respect to the user interface. As such, in certain embodiments, the apparatus 102 can support a mapping, navigation, location and/or transit applications so as to present maps or otherwise provide navigation or user assistance, such as in an example embodiment in which map data is created or updated using methods described herein. For example, in certain embodiments, the apparatus 102, such as the processing circuitry 106, can be configured to create a grid of points where each point can correspond to predicted location for a communication node.

In certain embodiments, the apparatus 102, such as the processing circuitry 106, can be configured to provide for display of a map and/or instructions for following a navigation route via a user interface (e.g., a graphical user interface). In order to support a mapping application, the apparatus 102 can include or otherwise be in communication with a location database, such as the radio model database 310, a location database stored in the memory 108, and/or another map database related to the radio model data service system 308. For example, the location database can include node data records, communication node locations, point of interest (POI) data records, real-line geometries, pedestrian access points, pedestrian entrance points, pedestrian exit points, public transit information, road transit information, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or global positioning system (GPS) data associations (such as using known or future map matching or geo-coding techniques), for example. Furthermore, other positioning technology can be used, such as electronic horizon sensors, radar, LiDAR, ultrasonic sensors and/or infrared sensors.

In example embodiments, a navigation system user interface can be provided to provide navigation assistance to a user traveling along a navigation route. Establishing improved locations and positions along a navigation route for a user can provide information useful to navigation, pedestrian routing, and/or urban mobility such that map features in the map, e.g., a high definition (HD) map, associated with the specific locations can be reliably used to aid in navigation, pedestrian routing, and/or urban mobility.

Referring back to FIG. 3, the radio model data service system 308 that manages such map data and/or model data can be in communication with one or more mobile devices via the network 312. The network 312 can be any form of wireless or partially wireless network as will be described further below. Additional, different, or fewer components can be provided. In an embodiment, the radio model data service system 308 can be a cloud service. For instance, in certain embodiments, the radio model data service system 308 can provide cloud-based services and/or can operate via a hosting server that receives, processes, and provides data to other elements of the system 300.

In certain embodiments, the radio model database 310 that can include communication node data records, transit segment or link data records, POI data records, real-line geometries, pedestrian access points, pedestrian entrance points, pedestrian exit points, transit platform information, and other data records. The radio model database 310 can also include routing data, in certain embodiments. According to some example embodiments, the road segment data records can be links or segments representing walkways, roads, streets, stairways, crosswalks, bridges, tunnels, elevators, escalators, or paths, as can be used in calculating a route or recorded route information for determination of one or more personalized routes. The node data can be end points corresponding to the respective links or segments of road segment data and/or transit data. The road link data and the node data can represent a transportation network, such as used by pedestrians, bicycles, scooters, vehicles, cars, trucks, buses, motorcycles, taxis, trains, subways, trams, planes and/or other entities. Optionally, the radio model database 310 can contain path segment and node data records or other data that can represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as transit stations, transit stops, transit connections, ride sharing connections, on-demand vehicle connections, fueling stations, hotels, restaurants, museums, stadiums, offices, auto repair shops, buildings, stores, parks, etc. The radio model database 310 can include data about the POIs and their respective locations in the POI records. The radio model database 310 can include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the radio model database 310 can include event data (e.g., traffic incidents, construction activities, scheduled events, unscheduled events, public transport events, venue events, etc.) associated with the POI data records or other records of the radio model database 310.

The radio model database 310 can be maintained by the radio model data service system 308 and can be accessed, for example, by the apparatus 102 of the radio model data service system 308. By way of example, the radio model data service system 308 can collect location data, geographic data and/or dynamic data to generate and enhance the radio model database 310. In one example, the dynamic data can include traffic-related data. In certain embodiments, remote sensing, such as aerial or satellite photography and/or LiDAR, can be used to generate at least a portion of map geometries directly or through machine learning.

In certain embodiments, map data can be compiled (e.g., such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to pedestrian navigation, vehicle navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases. In certain embodiments, the radio model database 310 can be used with a mobile device to provide a user with location, positioning, and/or navigation services. In such a case, one or more radio models and/or other maps stored in the radio model database 310 can be downloaded or stored on a mobile device which can access the radio model database 310 through a wireless or wired connection, such as via the network 312, for example.

In certain embodiments, the apparatus 102, such as the processing circuitry 106, can be configured to map the mobile device location 514 onto one or more map data layers of a map (e.g., a radio map, etc.) to facilitate navigation and/or routing associated with a user. For instance, in certain embodiments, the apparatus 102, such as the processing circuitry 106, can be configured to store the time to departure probability prediction in a map data layer of a map (e.g., a radio map, etc.) for positioning purposes, location purposes, mapping purposes, navigation purposes, and/or routing purposes. In certain embodiments, the apparatus 102, such as the processing circuitry 106, can be configured to link and/or associate the mobile device location 514 with one or more portions, components, areas, layers, features, text, symbols, and/or data records of a map (e.g., a radio map, etc.). In one or more embodiments, the apparatus 102, such as the processing circuitry 106, can be configured to generate a data point for a map layer based on the mobile device location 514. The data point can indicate a particular location for a communication node. Additionally or alternatively, in one or more embodiments, the apparatus 102, such as the processing circuitry 106, can be configured to store the data point in the radio model database 310 associated with a map layer.

In certain embodiments, at least a portion of the radio node data 402, the radio node data 504, and/or the radio node data 604 (e.g., an identifier for a radio node and/or coarse location information for one or more mobile devices) can be determined according to one or more predefined rules. The one or more predefined rules can additionally be configured for selecting hash keys. In various embodiments, modification of hashing function and/or hashing keys selection rule can be performed simultaneously via a server (e.g., where a radio model is created) and a client device that sent radio data probes and/or is configured for positioning. In various embodiments, old and new hashing functions and/or hashing keys can be aggregated in a radio model for a certain period of time until all radio models in a radio model database are associated with new hashed identifiers generated by a new hash function and/or hashing keys selection rules.

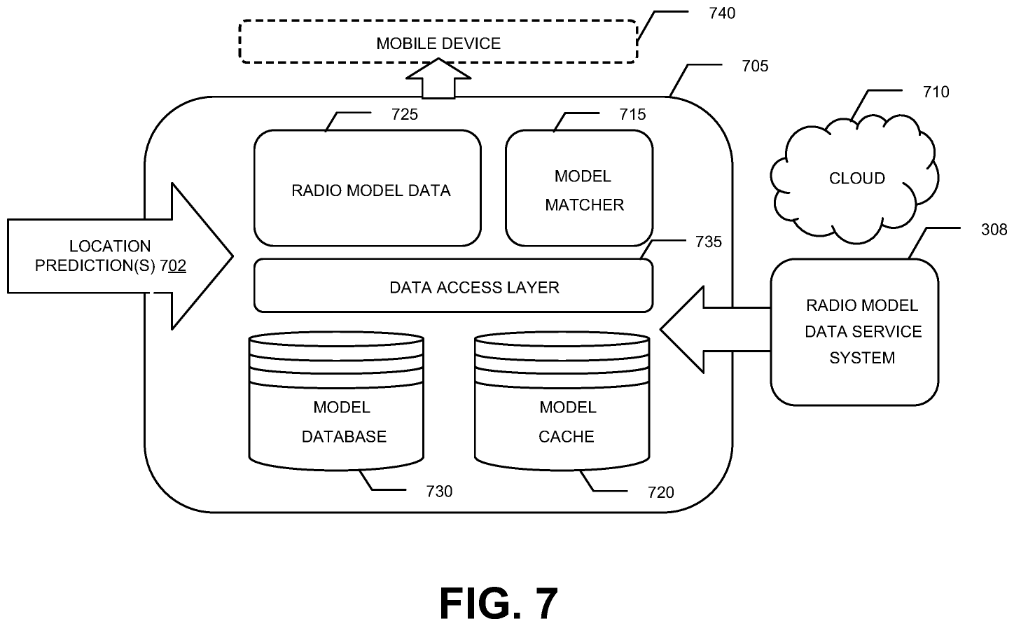

FIG. 7 illustrates an example embodiment of an architecture specifically configured for implementing embodiments described herein. The illustrated embodiment of FIG. 7 may be employed for position predictions, location predictions, navigation, routing and/or journey planning, where location prediction(s) 702 are determined for one or more communication nodes and/or one or more mobile devices. According to one or more embodiments, the location prediction(s) 702 can be correlated to radio model data of the radio model data service system 308. In certain embodiments, the location prediction(s) 702 can be correlated to one or more map data layers of a radio model. A mobile device may therefore acquire more accurate positioning information, location information, navigation information, routing information, transit information, and/or urban mobility information via the location prediction(s) 702. Additionally, the location prediction(s) 702 may provide a reduction in a number of queries and/or a number of displays via a user interface (e.g., a user interface of a mobile device) to facilitate navigation, routing, journey planning, and/or rendering of visual data via the user interface.

As illustrated in FIG. 7, the architecture includes the radio model data service system 308 that provides model data 725 (e.g., one or more radio models) to a mobile device 740. The radio model data service system 308 may be a cloud-based 710 service. In one or more embodiments, a server 705 receives the location prediction(s) 702 and may provide the location prediction(s) 702 to a model matcher 715. The model matcher 715 may correlate the location prediction(s) 702 to a link, segment and/or a probe point on a radio model stored in a model cache 720. In certain embodiments, the link, segment and/or probe point may be used to establish which model policies (e.g., radio model policies,) are applicable for providing positioning information, location information, navigation information, routing information, transit information, and/or urban mobility information to the mobile device 740. In certain embodiments, a data access layer 735 can manage and/or facilitate access to the model cache 720, the model data 725, and/or a model database 730. In an embodiment, at least a portion of the model database 730 can correspond to the radio model database 310. Additionally, in certain embodiments, the mobile device 740 can correspond to the mobile device 303.

By employing comparisons between frequency distribution data structures and timetable data structures to predict locations of communication nodes and/or mobile devices in accordance with one or more example embodiments of the present disclosure, precision and/or confidence of navigation, routing, and/or journey planning provided by a location service can be improved. Furthermore, by employing comparisons between frequency distribution data structures and timetable data structures to predict locations of communication nodes and/or mobile devices in accordance with one or more example embodiments of the present disclosure, optimized user interaction with respect to a user interface for navigation, routing, and/or journey planning can be provided. Moreover, in accordance with one or more example embodiments of the present disclosure, efficiency of an apparatus including the processing circuitry can be improved and/or the number of computing resources employed by processing circuitry can be reduced. In one or more embodiments, by employing comparisons between frequency distribution data structures and timetable data structures to predict locations of communication nodes and/or mobile devices in accordance with one or more example embodiments of the present disclosure, improved insights and/or recommendations related to rendered data for a user interface based on location can be provided.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Furthermore, in some embodiments, additional optional operations can be included. Modifications, additions, or amplifications to the operations above can be performed in any order and in any combination.

Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

That which is claimed:

1. An apparatus configured for radio map generation, the apparatus comprising processing circuitry and at least one memory including computer program code instructions, the computer program code instructions configured to, when executed by the processing circuitry, cause the apparatus to:
determine a presence of a first radio node in a radio environment;
determine at least one hash of the first radio node based at least in part on radio node data for a second radio node in the radio environment; and
configure at least a portion of a radio model for the first radio node based on the at least one hash.

2. The apparatus according to claim 1, wherein the computer program code instructions are configured to, when executed by the processing circuitry, cause the apparatus to:
determine the at least one hash of the first radio node based at least in part on location data for a mobile device in the radio environment.

3. The apparatus according to claim 1, wherein the computer program code instructions are configured to, when executed by the processing circuitry, cause the apparatus to:
determine the at least one hash of the first radio node based at least in part on identification data for the second radio node.

4. The apparatus according to claim 1, wherein the computer program code instructions are configured to, when executed by the processing circuitry, cause the apparatus to:
determine the at least one hash of the first radio node based at least in part on a predefined hash function associated with a classification of the second radio node data.

5. The apparatus according to claim 1, wherein the computer program code instructions are configured to, when executed by the processing circuitry, cause the apparatus to:
determine the second radio node based at least in part on a signal strength associated with the second radio node.

6. The apparatus according to claim 1, wherein the computer program code instructions are configured to, when executed by the processing circuitry, cause the apparatus to:
determine the second radio node based at least in part on timing data with respect to determination of the presence of the first radio node in the radio environment.

7. The apparatus according to claim 1, wherein the computer program code instructions are configured to, when executed by the processing circuitry, cause the apparatus to:
determine the second radio node based at least in part on a coverage area associated with the first radio node.

8. The apparatus according to claim 1, wherein the computer program code instructions are configured to, when executed by the processing circuitry, cause the apparatus to:
generate the radio model based on the at least one hash in response to a determination that a previously generated radio model does not exist for the at least one hash.

9. The apparatus according to claim 1, wherein the computer program code instructions are configured to, when executed by the processing circuitry, cause the apparatus to:
combine a first radio model and a second radio model to provide the radio model based on the at least one hash in response to a determination that the first radio model and the second radio model are both associated with a corresponding hash.

10. The apparatus according to claim 1, wherein the computer program code instructions are configured to, when executed by the processing circuitry, cause the apparatus to:
update one or more portions of the radio model based on the at least one hash.

11. An apparatus configured for mobile device positioning, the apparatus comprising processing circuitry and at least one memory including computer program code instructions, the computer program code instructions configured to, when executed by the processing circuitry, cause the apparatus to:
determine a presence of a first radio node in a radio environment;
determine at least one hash of the first radio node based at least in part on a predefined hash function and a hash key associated with radio node data for a second radio node in the radio environment;
retrieve a radio model from a radio model database based on the at least one hash; and
estimate a location of a mobile device based on the radio model retrieved from the radio model database.

12. The apparatus according to claim 11, wherein the computer program code instructions are configured to, when executed by the processing circuitry, cause the apparatus to:
determine the at least one hash of the first radio node based at least in part on location data for one or more mobile devices in the radio environment.

13. The apparatus according to claim 11, wherein the computer program code instructions are configured to, when executed by the processing circuitry, cause the apparatus to:
determine the at least one hash of the first radio node based at least in part on identification data for the second radio node.

14. The apparatus according to claim 11, wherein the computer program code instructions are configured to, when executed by the processing circuitry, cause the apparatus to:
determine the second radio node based at least in part on a signal strength associated with the second radio node.

15. The apparatus according to claim 11, wherein the computer program code instructions are configured to, when executed by the processing circuitry, cause the apparatus to:
determine the second radio node based at least in part on a timing data with respect to determination of the presence of the first radio node in the radio environment.

16. The apparatus according to claim 11, wherein the computer program code instructions are configured to, when executed by the processing circuitry, cause the apparatus to:
determine the second radio node based at least in part on a coverage area associated with the first radio node.

17. An apparatus configured for hash key generation for a radio model, the apparatus comprising processing circuitry and at least one memory including computer program code instructions, the computer program code instructions configured to, when executed by the processing circuitry, cause the apparatus to:
determine a presence of a first radio node in a radio environment;
determine a hash key based at least in part on radio node data for a second radio node in the radio environment or location data for a mobile device in the radio environment;
obfuscate one or more portions of the hash key to generate an obfuscated hash key; and
transmit the obfuscated hash key to a server configured to manage radio models for radio nodes.

18. The apparatus according to claim 17, wherein the computer program code instructions are configured to, when executed by the processing circuitry, cause the apparatus to:
determine the hash key based at least in part on identification data for the second radio node.

19. The apparatus according to claim 17, wherein the computer program code instructions are configured to, when executed by the processing circuitry, cause the apparatus to:
determine the hash key based at least in part on location data for the second radio node.

20. The apparatus according to claim 17, wherein the computer program code instructions are configured to, when executed by the processing circuitry, cause the apparatus to:
determine the second radio node based at least in part on a signal strength associated with the second radio node.
